(19) United States
(12) Patent Application Publication
(10) Pub. No.: US 2008/0169933 A1
(43) Pub. Date: Jul. 17, 2008

(54) SOUND CONTROL SYSTEM WITH AN AUTOMATIC SOUND RECEIVING FUNCTION

(75) Inventors: Min-hong Wang, Taoyuan Hsien (TW); Jia-lin Shen, Taoyuan Hsien (TW); Tien-ming Hsu, Taoyuan Hsien (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: DELTA ELECTRONICS, INC., Taoyuan Hsien (TW)

(21) Appl. No.: 11/752,663

(22) Filed: May 23, 2007

(30) Foreign Application Priority Data
Jan. 12, 2007 (TW) 096101363

(51) Int. Cl. G08B 23/00

(52) U.S. Cl. 340/584

(57) ABSTRACT

A sound control system with an automatic sound receiving function is provided. The sound control system includes a sensor sensing a trigger signal; a sound receiving apparatus coupled with the sensor to initiate a receiving of a sound according to the trigger signal, and a sound control unit coupled with the sound receiving apparatus and operating according to the sound received from the sound receiving apparatus.

### FIELD OF THE INVENTION

The present invention relates to a sound control system, and more particularly to a sound control system with an automatic sound receiving function.

### BACKGROUND OF THE INVENTION

For the options to turn on a sound receiving apparatus of a sound control system for the sound receiving, besides regular control switches, the other common ways are “Push To Talk” (PTT) and “Voice Trigger.” However, there exist limitations and inconveniences therein.

When controlling the turning-on/off of the sound receiving apparatus by PTT, it is necessary to design an independent button additionally thereon, and the user must press this button to initiate the sound receiving before inputting a sound. Furthermore, it results in inconveniences for the user if he is not free-handed to carry out a motion of pressing the button, and it consequently limits the availability of the sound receiving apparatus.

In order to solve the above-mentioned problems, a voice triggering method is developed to turn on the sound receiving apparatus for the sound receiving by a sound. The sound receiving apparatus is usually in a standby status and is turned on entirely after a predefined “Trigger Word” spoken by the user is identified. Afterward, the sound receiving apparatus records a following sound or receives a subsequent sound command. The method is commonly applied to electronic devices which are turned on by a voice identification device, such as an electronic sound control switch.

Nevertheless, in the above-mentioned method, the sound receiving apparatus must always keep in a standby status to receive the Trigger Word spoken by the user. Therefore, it is relatively power-consuming to some micro-electronic devices stressed on power-saving. Furthermore, the failure of the Trigger Word to turn on the sound receiving apparatus, caused by an erroneous identification of the voice identification device, requires a repetitive expression thereof. In addition, a rate of the erroneous identification increases because the voice identification device is easy to be interfered by a background noise as a result of the continuous sound receiving.

Moreover, if the user forgets or does not know the Trigger Word, the sound receiving apparatus can not be turned on. Additionally, a necessity of saying the Trigger Word every time before using the system annoys the user easily because of a lack of humanity of the system.

From the above description, it is known that how to develop a sound control system with an automatic sound receiving function has become a major problem to be solved. In order to overcome the drawbacks in the prior art, an improved sound control system is provided. The particular design in the present invention not only solves the problems described above, but also is easy to be implemented. Thus, the invention has the utility for the industry.

### SUMMARY OF THE INVENTION

In accordance with one aspect of the present invention, a sound control system with an automatic sound receiving function is provided. The sound control system is able to turn on a sound receiving apparatus for the sound receiving thereof without the user's additional action.

In accordance with another aspect of the present invention, a sound control system with an automatic sound receiving function is provided. The sound control system includes a sensor, a sound receiving apparatus, and a sound control unit. The sensor transmits a turning on signal to the sound receiving apparatus through a first transmission module when sensing a trigger signal. In response to the turning on signal, the sound receiving apparatus is turned on and starts to receive a sound. After that, the sound received is transmitted to the sound control unit through a second transmission module, and the sound control unit executes a command according to the sound received.

Preferably, the sensor is one selected from a group including of a temperature sensor, a vibration detector, an image sensor, and a combination thereof.

Preferably, a level of the sensitivity or a range of the sensor is adjustable.

Preferably, the sound receiving apparatus is a microphone.

Preferably, the sound received is one selected from a group including of a speech, a voice, an episode of a music, a ring, a sound with a specific pulse/pitch, and a combination thereof.

Preferably, the first transmission module is one of a wired transmission module and a wireless transmission module.

Preferably, the second transmission module is one of a wired transmission module and a wireless transmission module.

Preferably, the sound receiving apparatus is shut down by a shutting down signal.

Preferably, the shutting down signal is generated after the trigger signal vanishes.

In accordance with a further aspect of the present invention, a method for sound control with the automatic sound receiving is provided. The method includes steps of (a) sensing a trigger signal, (b) starting to receive a sound in response to the sensing of the trigger signal, and (c) executing a command according to the sound received.

Preferably, the trigger signal in the step (a) is one selected from a group consisting of a human body temperature, an external vibration, a default image, and a combination thereof.

Preferably, the step (a) is achieved by sensing an existence of one selected from a group consisting of a human body temperature, an external vibration, a default image, and a combination thereof.

Preferably, a relationship between the sound and the command is set up in advance.

In accordance with further another aspect of the present invention, a method for sound control with the safety and automatic sound receiving is provided. The method includes steps of (a) providing a trigger signal, (b) sensing the trigger signal, (c) identifying the trigger signal, (d) transmitting a turning on signal to turn on a sound receiving apparatus to receive a sound if the trigger signal is identified as a correct trigger signal, and (e) proceeding an act according to the sound received.

Preferably, the step (a) is achieved by sensing an existence of one selected from a group consisting of a human body temperature, an external vibration, a default image, and a combination thereof.

Preferably, a relationship between the sound and the command is set up in advance, and the step (c) is performed by one selected from a group consisting of a fingerprint identification device, a human face identification device, and a combination thereof.

The above aspects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a schematic diagram showing the sound control system with an automatic sound receiving function according to a preferred embodiment of the present invention;

FIG. 2 is a schematic diagram showing the sound control system with an automatic sound receiving function according to another preferred embodiment of the present invention; and

FIG. 3 is a schematic diagram showing the sound control system with the safety and automatic sound receiving according to a preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

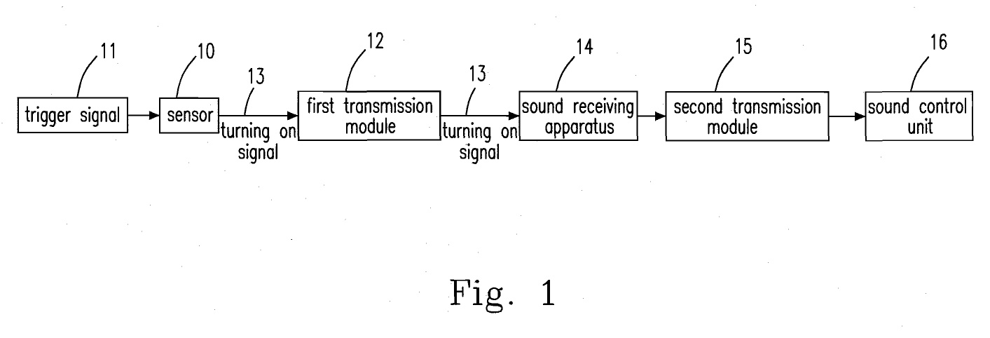

Please refer to FIG. 1, which shows the sound control system with an automatic sound receiving function according to a preferred embodiment of the present invention. The sound control system with an automatic sound receiving function includes a sensor 10, a trigger signal 11, a first transmission module 12, a turning on signal 13, a sound receiving apparatus 14, a second transmission module 15, and a sound control unit 16, wherein the sensor 10 is coupled to the sound receiving apparatus 14 by the first transmission module 12, and the sound receiving apparatus 14 is coupled to the sound control unit 16 by the second transmission module 15.

When sensing the trigger signal 11, the sensor 10 transmits the turning on signal 13 to the sound receiving apparatus 14 by the first transmission module 12, and the sound receiving apparatus 14 starts to receive a sound. The sound received is transmitted to the sound control unit 16 by the second transmission module 15, and the sound control unit 16 executes a command according to the sound received by the sound receiving apparatus 14.

According to the sound control system of FIG. 1, the sensor 10 and the sound receiving apparatus 14 are able to be applicable to different devices such as a temperature sensor installed in a cell phone. The temperature sensor senses a human body temperature from the user's cheek as a trigger signal, and turns on the sound receiving apparatus in the cell phone thereby. Consequently, the user executes all sound control commands predefined in the cell phone without any other additional actions.

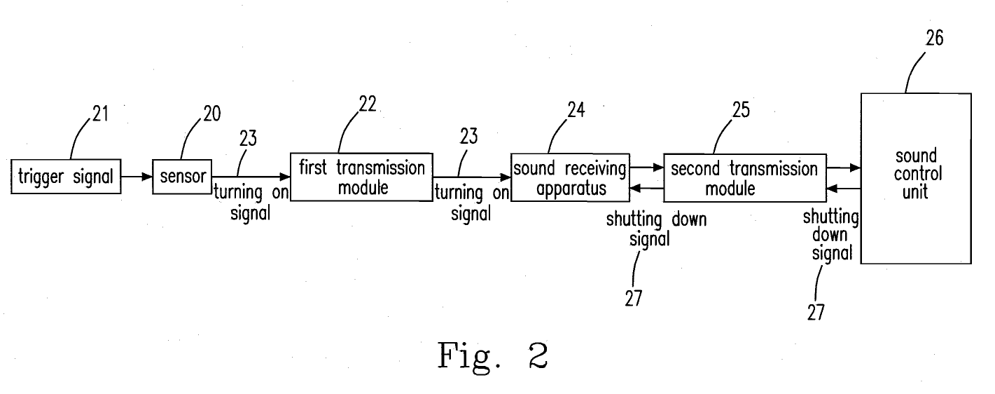

Please refer to FIG. 2, which shows the sound control system with an automatic sound receiving function according to another preferred embodiment of the present invention. The sound control system with an automatic sound receiving function includes a sensor 20, a trigger signal 21, a first transmission module 22, a turning on signal 23, a sound receiving apparatus 24, a second transmission module 25, a sound control unit 26, and a shutting down signal 27, wherein the sensor 20 is coupled to the sound receiving apparatus 24 by the first transmission module 22, and the sound receiving apparatus 24 is coupled to the sound control unit 26 by the second transmission module 25.

When sensing the trigger signal 21, the sensor 20 transmits the turning on signal 23 to the sound receiving apparatus 24 by the first transmission module 22, and the sound receiving apparatus 24 starts to receive a sound. The sound received is transmitted to the sound control unit 26 by the second transmission module 25, and the sound control unit 26 executes a command according to the sound received by the sound receiving apparatus 24. In the end, when the user stops inputting a sound, the sound control unit 26 generates the shutting down signal 27 because of the vanishment of the turning on signal 23, and the sound receiving apparatus 24 is shut down by the shutting down signal 27 transmitted by the second transmission module 25.

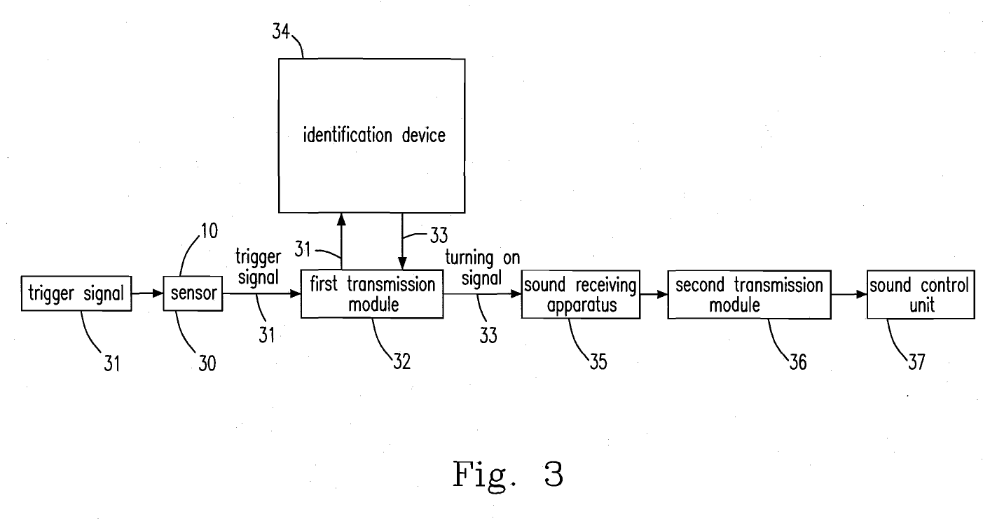

Please refer to FIG. 3, which shows the sound control system with the safety and automatic sound receiving according to a preferred embodiment of the present invention. The sound control system with a safety and an automatic sound receiving function includes a sensor 30, a trigger signal 31, a first transmission module 32, a turning on signal 33, an identification device 34, a sound receiving apparatus 35, a second transmission module 36, and a sound control unit 37, wherein the sensor 30, the sound receiving apparatus 35 and the identification device 34 are coupled to each other by the first transmission module 32, and the sound receiving apparatus 35 is coupled to the sound control unit 37 by the second transmission module 36.

When sensing the trigger signal 31, the sensor 30 transmits the trigger signal 31 to the identification device 34 for signal identification. When the trigger signal 31 is identified as a correct trigger signal by the identification device 34, the identification device 34 transmits a turning on signal 33 to the sound receiving apparatus 35 by the first transmission module 32, and the sound receiving apparatus 35 starts to receive a sound. After that, the sound received is transmitted to the sound control unit 37 by the second transmission module 36, and the sound control unit 37 proceeds an act according to the sound received by the sound receiving apparatus 35. If the trigger signal 31 is identified as an incorrect trigger signal by the identification device 34, the identification device 34 proceeds no acts.

In conclusion, the sound control system of the present invention provides an automatic sound receiving function for the user. Accordingly, the present invention can effectively solve the problems and drawbacks in the prior art, and thus it fits the demand of the industry and is industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A sound control system with an automatic sound receiving function, comprising:
a sensor sensing a trigger signal;
a sound receiving apparatus coupled with the sensor to initiate a receiving of a sound according to the trigger signal; and
a sound control unit coupled with the sound receiving apparatus and operating according to the sound received from the sound receiving apparatus.

2. A sound control system according to claim 1, wherein the sensor is one selected from a group consisting of a temperature sensor, a vibration detector, an image sensor, and a combination thereof.

3. A sound control system according to claim 1, wherein the sound receiving apparatus is a microphone.

4. A sound control system according to claim 1, wherein a received sound is one selected from a group consisting of a speech, a voice, an episode of a music, a ring, a sound with a specific pulse/pitch and a combination thereof.

5. A sound control system according to claim 1 further comprising a first transmission module, wherein the sound receiving apparatus is coupled to the sensor by the first transmission module.

6. A sound control system according to claim 5, wherein the first transmission module is one of a wired transmission module and a wireless transmission module.

7. A sound control system according to claim 1 further comprising a second transmission module, wherein the sound control unit is coupled to the sound receiving apparatus by the second transmission module.

8. A sound control system according to claim 7, wherein the second transmission module is one of a wired transmission module and a wireless transmission module.

9. A sound control system according to claim 1, wherein the sound receiving apparatus is shut down by a shutting down signal.

10. A sound control system according to claim 9, wherein the shutting down signal is generated after the trigger signal vanishes.

11. A method for sound control with an automatic sound receiving, comprising steps of:
(a) sensing a trigger signal;
(b) starting to receive a sound in response to the sensing of the trigger signal; and
(c) executing a command according to the sound received.

12. A method for sound control according to claim 11, wherein the step (a) is achieved by sensing an existence of a human body temperature.

13. A method for sound control according to claim 11, wherein the step (a) is achieved by sensing an existence of an external vibration.

14. A method for sound control according to claim 11, wherein the step (a) is achieved by sensing an existence of a default image.

15. A method for sound control according to claim 11, wherein a relationship between the sound and the command is set up in advance.

16. A method for sound control with a safety and automatic sound receiving, comprising steps of:
(a) providing a trigger signal;
(b) sensing the trigger signal;
(c) identifying the trigger signal;
(d) transmitting a turning on signal to turn on a sound receiving apparatus to receive a sound if the trigger signal is identified as a correct trigger signal; and
(e) proceeding an act according to the sound received.

17. A method for sound control according to claim 16, wherein the step (b) is achieved by sensing an existence of a human body temperature.

18. A method for sound control according to claim 16, wherein the step (b) is achieved by sensing an existence of an external vibration.

19. A method for sound control according to claim 16, wherein the step (b) is achieved by sensing an existence of a default image.

20. A method for sound control according to claim 16, wherein a relationship between the act and the sound is set up in advance, and the step (c) is performed by one selected from a group consisting of a fingerprint identification device, a human face identification device, and a combination thereof.
